(19) United States
(12) Patent Application Publication
(10) Pub. No.: US 2022/0325199 A1
(43) Pub. Date: Oct. 13, 2022

(54) A PROCESS FOR THE PRODUCTION OF DEGUMMED OIL AND GUMS, AND PRODUCTS PRODUCED BY THE PROCESS

(71) Applicant: COMMONWEALTH SCIENTIFIC AND INDUSTRIAL RESEARCH ORGANISATION, Acton, Australian Capital Territory (AU)

(72) Inventors: Mohamed A. Fouad M. Gaber, Acton (AU); Pablo Juliano, Acton (AU); Maged Peter Mansour, Acton (AU); Rod Smith, Acton (AU)

(21) Appl. No.: 17/639,289

(22) PCT Filed: Aug. 31, 2020
(86) PCT No.: PCT/AU2020/050917

§ 371 Date: Feb. 28, 2022

(30) Foreign Application Priority Data
Aug. 29, 2019 (AU) 2019903169

(51) Int. Cl. C11B 1/10; C11B 3/04; C11B 3/06

(52) U.S. Cl. CPC C11B 1/106; C11B 1/108; C11B 3/04; C11B 3/06

(57) ABSTRACT

The present disclosure relates to a process for refining crude oils using a combination of a chemical process and mega-sonic treatment to simultaneously and efficiently separate oil and gum phases. In particular, the present disclosure relates to a process for refining crude oils using a combination of chemical processes followed by megasonic treatment to effectively separate and recover entrained oil from a gum phase to increase the oil yield, and to produce an oil of higher quality with reduced gum content. The present disclosure also relates to a process for refining crude oils using a combination of chemical processes followed by megasonic treatment to effectively separate and recover entrained gums from an oil phase to increase the gum yield, and to produce a gum of higher quality with reduced oil content. The present disclosure also relates to obtaining refined oils and refined gums from the process described herein.

### FIELD

The present disclosure relates to a process for refining crude oils using a combination of a chemical process and megasonic treatment to simultaneously and efficiently separate oil and gum phases. The present disclosure also relates to obtaining refined oils and refined gums from the process.

### BACKGROUND

Crude oils are refined in order to remove or reduce the amount of impurities therein, such as phospholipid gums, phosphatides, mucilaginous substances, free fatty acids, odiferous volatiles, pigments, waxes and metal compounds. Such impurities can negatively affect taste, smell, appearance, and storage stability of the crude oil, and hence must be removed by refining processes to yield a more stable product with acceptable organoleptic characteristics appropriate for its end use. Crude oil cannot be used directly without proper refining processes due to the unacceptable flavour, colour, odour, appearance and short shelf life. This has led to the development of refining processes which involve removing or reducing the levels of impurities whilst attempting to retain the desired components of the oil (such as carotenoids, tocopherols, phenols and phytosterols) and/or maximising oil yield.

Typically, refining processes include water and/or acid degumming, alkali neutralisation, bleaching, winterisation and deodorisation. However, some disadvantages of refining crude oils in this way include reduced oil yield through losses in emulsion separation and hydrolysis during degumming and neutralisation, higher investment cost, increased chemical use, and higher volumes of waste streams.

Gums are often a byproduct of oil refining, and as a result, suffer from some of the same disadvantages described above. In such cases, they are of lower value than the refined oil. Similar to oils, recovery of gums from the oil refining process can also be economically significant, as some gums can be defatted of entrained oil and refined to produce high value co-products such as different grades of lecithins.

Consequently, there is a need to improve upon the currently known techniques for obtaining refined oils and/or refined gums from crude oil.

### SUMMARY

The present disclosure relates to a process for refining crude oils using a combination of chemical processes followed by megasonic treatment to effectively separate and recover entrained oil from a gum phase to increase the oil yield, and to produce an oil of higher quality with reduced gum content.

The present disclosure also relates to a process for refining crude oils using a combination of chemical processes followed by megasonic treatment to effectively separate and recover entrained gums from an oil phase to increase the gum yield, and to produce a gum of higher quality with reduced oil content.

The present inventors have found that oil loss can be minimised through enhanced extraction of entrained or trapped oil in gums post degumming through subsequent megasonic treatment of the degummed mixture. It has been found that selectively removing a higher proportion of gums from the crude oil can reduce the use and/or amount of chemicals (such as acid in the acid degumming stage and/or alkali in the neutralisation stage) which minimises losses of oil in emulsion separation as entrained oil, soaps and/or hydrolysis products. Consequently, due to the improved efficiency of gum and oil separation and increased oil and gum recovery, significant energy savings may be achieved, due to reduced chemical usage and requirements for separation energy. One or more advantages of the present disclosure according to at least some embodiments or examples as described herein is that an enhanced removal of impurities from crude oils, which requires less harsh refining conditions and less refining steps, produces a higher quality oil and/or a higher quality gum with higher yields.

The present inventors have found that the yield and quality of oils and gums can be increased by this process simultaneously due to a higher proportion of gums being removed from the oil and a higher proportion of oil being removed from the gum.

In one aspect there is provision for a process for refining crude oil to produce a refined oil and/or a refined gum, the process comprising the following steps:

(a) subjecting the crude oil to a chemical process to produce a mixture comprising an oil phase and a gum phase; and

(b) subjecting the mixture obtained in step (a) to a megasonic treatment step, wherein megasonic frequencies of at least about 100 kHz are used to produce a refined oil phase and/or a refined gum phase; and

(c) separating the phases obtained in step (b) to obtain a refined oil and/or a refined gum.

In an embodiment, the crude oil may be selected from the group comprising oil, fat, lipid or oil bearing material. For example, the crude oil may comprise or consist of at least one of animal oil, fish oil, plant oil, or vegetable oil.

In another embodiment, in step (a) the chemical process may comprise addition of water, at least one acid, at least one alkali, or a combination thereof. The at least on acid may be selected from phosphoric acid, hydrochloric acid, sulfuric acid, ascorbic acid, formic acid, acetic acid, propionic acid, citric acid, fumaric acid, maleic acid, tartaric acid, succinic acid, glycolic acid, carbonic acid, nitric acid, ionic liquids or combinations thereof. For example, the acid may be selected from phosphoric acid or citric acid. The at least one alkali may be selected from sodium hydroxide, potassium hydroxide, aqueous ammonia, sodium silicate, sodium carbonate, sodium bicarbonate, organic and inorganic bases such as amines, ammonium salts, ionic liquids, calcium carbonate, or combinations thereof. For example, the base may be selected from sodium hydroxide or potassium hydroxide.

In another embodiment, in step (b) the megasonic treatment step may comprise the use of megasonic frequencies of about 100 kHz to about 10 MHz.

In another embodiment, in step (a) the crude oil may be subjected to a temperature of about 0° C. and 150° C. In yet another embodiment, in step (b) the mixture may be subjected to a temperature of about 0° C. and 150° C.

In another embodiment, in step (b) the mixture may be further subjected to a high shear mixing step.

In an embodiment, the % reduction of entrained oils in gums (on a wet weight basis) may be in a range of about 20% to about 60%.

In an embodiment, the recovered gums that contains less than about 60% of crude oil on a dry weight basis.

In another aspect, there is provided a refined oil and a refined gum prepared by the process of any one of the embodiments or examples described herein.

### BRIEF DESCRIPTION OF THE FIGURES

Some embodiments of the present disclosure are described and illustrated herein, by way of example only, with reference to the accompanying Figures in which:

FIG. 1a shows the effect of megasonic frequencies and treatment temperature of pre-sheared canola oil after acid degumming.

FIG. 1b shows the effect of 2 MHz frequency and 40° C. treatment parameters on two types of canola oil, sunflower oil and soybean oil after acid degumming.

FIG. 2 shows the effect of megasonic treatment after water, citric acid, phosphoric acid and total degumming processes on phospholipid removal from crude canola oil.

### DETAILED DESCRIPTION

### General Terms

Throughout this disclosure, unless specifically stated otherwise or the context requires otherwise, reference to a single step, composition of matter, group of steps or group of compositions of matter shall be taken to encompass one and a plurality (i.e. one or more) of those steps, compositions or matter, groups of steps or groups of composition of matter. Thus, as used herein, the singular forms “a”, “an” and “the” include plural aspects unless the context clearly indicates otherwise. For example, reference to “a” includes a single as well as two or more; reference to “an” includes a single as well as two or more; reference to “the” includes a single as well as two or more and so forth.

Those skilled in the art will appreciate that the disclosure herein is susceptible to variations and modifications other than those specifically described. It is to be understood that the disclosure includes all such variations and modifications. The disclosure also includes all of the steps, features, compositions and compounds referred to or indicated in this specification, individually or collectively, and any and all combinations or any two or more of said steps or features.

Each example of the present disclosure described herein is to be applied mutatis mutandis to each and every other example unless specifically stated otherwise. The present disclosure is not to be limited in scope by the specific examples described herein, which are intended for the purpose of exemplification only. Functionally-equivalent products, compositions and methods are clearly within the scope of the disclosure as described herein.

The term “and/or”, e.g., “X and/or Y” shall be understood to mean either “X and Y” or “X or Y” and shall be taken to provide explicit support for both meanings or for either meaning.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

The term “consists of”, or variations such as “consisting of”, refers to the inclusion of any stated element, integer or step, or group of elements, integers or steps, that are recited in context with this term, and excludes any other element, integer or step, or group of elements, integers or steps, that are not recited in context with this term.

Unless otherwise indicated, the terms “first”, “second”, etc. are used herein merely as labels, and are not intended to impose ordinal, positional, or hierarchical requirements on the items to which these terms refer. Moreover, reference to a “second” item does not require or preclude the existence of lower-numbered item (e.g., a “first” item) and/or a higher-numbered item (e.g., a “third” item).

As used herein, the phrase “at least one of”, when used with a list of items, means different combinations of one or more of the listed items may be used and only one of the items in the list may be needed. The item may be a particular object, thing, or category. In other words, “at least one of” means any combination of items or number of items may be used from the list, but not all of the items in the list may be required. For example, “at least one of item A, item B, and item C” may mean item A; item A and item B; item B; item A, item B, and item C; or item B and item C. In some cases, “at least one of item A, item B, and item C” may mean, for example and without limitation, two of item A, one of item B, and ten of item C; four of item B and seven of item C; or some other suitable combination.

Reference herein to “example,” “one example,” “another example,” or similar language means that one or more feature, structure, element, component or characteristic described in connection with the example is included in at least one embodiment or implementation. Thus, the phrases “in one example,” “as one example,” and similar language throughout the present disclosure may, but do not necessarily, refer to the same example. Further, the subject matter characterising any one example may, but does not necessarily, include the subject matter characterising any other example.

It will be clearly understood that, although a number of prior art publications are referred to herein, this reference does not constitute an admission that any of these documents forms part of the common general knowledge in the art, in Australia or in any other country.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. In case of conflict, the present specification, including definitions, will control. In addition, the materials, methods, and examples are illustrative only and not intended to be limiting.

### Chemical Process

Crude oils consist of a complex mixture of glycerides (mainly triacylglycerols and partially diacylglycerols and monoacylglycerols), glycolipids, hydrocarbons, alcohols, phospholipids, free fatty acids, pigments, sterols, tocopherols, and volatile compounds, for example. Typically an oil refining process is used to eliminate the unwanted minor components, which make these oils unsuitable for sale and consumption. All compounds, which are detrimental to flavour, colour, stability, and safety of the refined final oil products will be removed. They are primarily phospholipids, glycolipids, free fatty acids, pigments, trace metals, volatiles, persistent organic pollutants (POPs), and other impurities. Conventional oil refining processes consist of four steps i.e., degumming, neutralization, decolourisation (bleaching), and deodorization.

A degumming process is traditionally used to separate, for example, phospholipid gums that are insoluble in oil when hydrated. The separation process typically involves mixing and centrifugation. The two main types of gums that need to be removed are hydratable phosphatides and non-hydratable phosphatides. Non-hydratable phosphatides are typically difficult to remove from the crude oil and require a conversion step. In some cases non-hydratable phosphatides may be removed with the hydratable phosphatides during water degumming, and may require the use of an acid to convert the non-hydratable phosphatides to hydratable phosphatides for further removal. In addition to the removal of gums undesirable impurities may also be removed, such as glycolipids and other polar lipids, fatty acid soaps, free fatty acids, waxes, colour pigments, peroxides, and oxidation by products. Other extraction methods less commonly applied to degumming may include enzymes or hexane (known as micelle degumming) or acetone extraction. Neutralization, also known as alkali refining, is used to eliminate free fatty acids as free fatty acid soaps (soapstock) that can promote lipid oxidation by forming. The soapstock can be split back into free fatty acids and water by acidification using a strong acid like sulphuric or hydrochloric acid.

The present disclosure describes a novel process for refining crude oil to produce a refined oil and/or a refined gum wherein the process comprises high shear mixing of crude oils with water, at least one aqueous or non-aqueous acid such as phosphoric or citric acid (known as water and acid degumming, respectively), at least one alkali (known as alkali neutralisation or alkali refining), or a combination thereof (known as total degumming or chemical refining), followed by a megasonic treatment step and centrifugation step to separate the refined oil in high yields from the gum and aqueous phases. In some embodiments or examples, the chemical process, as described herein, may be selected from water degumming, acid degumming, alkali neutralisation, total degumming, or a combination thereof. For example, the present disclosure describes a novel process for refining crude oil to produce a refined oil and/or a refined gum wherein the process comprises high shear mixing of crude oils with water degumming process, followed by a megasonic treatment step and centrifugation step to separate the refined oil in high yields from the gum and aqueous phases. In another example, the present disclosure describes a novel process for refining crude oil to produce a refined oil and/or a refined gum wherein the process comprises high shear mixing of crude oils with a water degumming and/or acid degumming process, followed by a megasonic treatment step and centrifugation step to separate the refined oil in high yields from the gum and aqueous phases. In yet another example, the present disclosure describes a novel process for refining crude oil to produce a refined oil and/or a refined gum wherein the process comprises high shear mixing of crude oils with a alkali neutralisation process, followed by a megasonic treatment step and centrifugation step to separate the refined oil in high yields from the gum and aqueous phases. In yet another example, the present disclosure describes a novel process for refining crude oil to produce a refined oil and/or a refined gum wherein the process comprises high shear mixing of crude oils with a total degumming process, followed by a megasonic treatment step and centrifugation step to separate the refined oil in high yields from the gum and aqueous phases.

The inventors have surprisingly found that the process for refining crude oil to produce a refined oil and/or a refined gum as described herein effectively separates refined oil phases and refined gum phases from each other with reduced oil and gum losses from the unexpected combination of a chemical process with megasonic treatment. The combined process described herein also unexpectedly provides refined oils and/or refined gums with an improved quality and yield.

Gums or sludge are a complex mixture comprising phospholipids or lecithin, oil, and minor amounts of other constituents like glycolipids, sterols, tocopherols, and fatty acids. They have a high-water content that rapidly promotes damage if they are not properly stored and processed. The composition and molecular structure of this heterogeneous mixture of compounds vary depending on the degumming conditions of the oil.

As used herein, “crude oil” (also referred to as a non-degummed oil) refers to a pressed or extracted oil or a mixture thereof from, for e.g. oil bearing materials such as seeds (e.g. canola, soybean, grapeseed, cottonseed, flaxseed, hemp, banana leaf and genetically engineered plants), fruits and bio-products thereof (e.g. palm, olive, coconut, moringa, avocado oils, mango seed oils), vegetables (e.g. corn oil, sorghum seed oil), peels or pomaces (e.g. citrus oil), plant terpenes, beans (e.g. spent coffee), or other oily plant parts (e.g., rice bran; GM tobacco leaves). It will also be appreciated that the term “crude oil” as described herein may also apply to animal oil or fat, (e.g., tallow, wool lipids) or oil from other biological sources (e.g. algal or marine), as well as waste water by-products and dissolved organic compounds.

Any process that includes separation of components such as, but not limited to, organic compounds found in plant and biological matrices (e.g. plant/fish meal/oil), marine plants (e.g. algae, heterotrophs, bacteria, yeasts, fungi, blood/blood meal and organic constituents in wastewater streams from abattoirs or slaughterhouse) such as oil soluble components, free fatty acids or derivatives or compounds containing lipid moieties, such as, but not limited to: esters of fatty acids such as fatty acid methyl/ethyl ester, salts, soaps as in soap-stock, hydroxy fatty acids and derivatives, derivatives of lipids or complex biological lipids found in abattoir or slaughterhouse wastewater streams containing fats, oil and grease (FOG), diglycerides, monoglycerides, triglycerides phosphatides, waxes, lignans, hydrocarbons, terpenes, cannabinoids from cannabis, hemp and hemp pressed cake and fines (mud), sterols, sterol esters, long chain alcohols, pigments, antioxidants, peroxides, and oxidation by-products as well as health promoting compounds such as phenolics, flavonoids, polyphenolics, glycosides, fibre, carbohydrates, amino acids, peptides, vitamins, oil soluble compounds such as tocopherols, tocotrienols, carotenoids, and anti-nutritional and/or bioactive compounds found in plants and their oil and polar solvent extracts (e.g. in oil seeds) such as glucosinolates, thymoquinone from blackseed oil may also be included by the term “crude oil” as described herein.

As used herein, the term “gum phase” means an aqueous gum phase, or organic solvent gum phase (e.g. hexane; alcohols such as ethanol; or acetone); in the form of an emulsion (liquid/liquid) or dispersion (solid/liquid) or slurry (solid/liquid); or a crude separated gum, resulting from a degumming process. Similarly, the term “oil phase” means an oil phase derived from crude oil that has been subjected to a degumming process.

As used herein, the terms “refined oil phase” and “refined gum phase” means the phases resulting from a combined chemical and megasonic treatment process.

As used herein, the term “refined oil” means an oil that is substantially reduced in gum content. As used herein, the term “refined gum” means a gum that is substantially reduced in oil content or other compounds or impurities.

### Megasonic Process

The present disclosure utilizes the application of high ultrasound frequencies, also referred herein as megasonic frequency or megasonic/s, subsequent to the mixing steps in the degumming process of crude oil refining, and prior to centrifugation, to improve the degumming process by effectively separating and recovering oil or other compounds entrained in gums, e.g. lecithin. One or more advantages of the present disclosure according to at least some embodiments or examples as described herein is to avoid industrial oil losses in gums during degumming stages in oil refining by minimising residual oil in gums post-centrifugation. It has been surprisingly found that the unexpected combination of degumming with megasonic treatment effectively separates refined oil phases and refined gum phases from each other with reduced oil and gum losses. The combined process described herein also surprisingly provides refined oils and/or refined gums with an improved quality and yield.

The present disclosure describes the application of high frequency ultrasound to the degummed mixture before the separation step, to improve the degumming processes and co-products (e.g. lecithin) quality.

High frequency ultrasonic waves have a different operating mechanism to low frequency ultrasound (18 to below 100 kHz). The application of high frequency ultrasound does not involve implosions of unstable cavitation bubble that results in strong localised heating and emulsification. High frequency driven ultrasound separations make use of two main physical mechanisms: (a) the formation of larger amount of smaller and stable cavitation bubbles which create localised microstreaming effects that promote mass transfer of substances between phases, and (b) solid or liquid trapping effects in nodal or antinodal planes, respectively, across stationary waves. These mechanisms promote oil droplet coalescence and solid material agglomeration.

Application of high frequency ultrasound may also enable cost savings and environmental benefits through reduction in water use, energy, or reagent (water, enzyme, acid, alkali) requirements and selective removal of phospholipids and/or other impurities. The method described by the present invention may enable the production of higher quality gums and novel or existing gum co-products (e.g. lecithin of various grades).

The application of megasonics may also enhance enzymatic or physically-driven phospholipid degradation reactions and the removal of phospholipids or other impurities and thereby improve the quality of the refined oil.

### Crude Oils

The technology described by the present disclosure may be applicable in the chemical processing of plant or vegetable fats and/or oils, animal fats and/or oils, or fats/oils from other biological sources (e.g., algal or marine fats/oils), as well as fats/oils and dissolved organic compounds from wastewater streams such as in meat processing.

In some embodiments or examples, the animal oil or fat may be selected from the group comprising fish oil, krill oil, squid oil, mussel oil, oyster oil, fish liver oil, seafood oil, micro-algal oil, macro-algal oil, lanolin, beef fat, pork fat, chicken fat, lamb fat, egg fat, tallow, dripping, seal oil, whale oil, wool oil, fish eggs oil, animal products oil, animal tissue oil, animal organ oil, animal blood oil, and associated animal meal oil from processing.

In some embodiments or examples, the plant oil or vegetable oil is selected from the group comprising plant leaf oil, palm oil, marine plant oil, micro-algal oil, macro-algal oil, palm kernel oil, coconut oil, nut oil, seed oil, clove oil, perilla oil, moringa seed oil, almond oil, avocado oil, avocado seed oil, banana leaf oil, canola oil, cocoa butter, corn oil, cottonseed oil, flax seed oil, blackseed oil, grapeseed oil, hemp oil, cannabis oil, olive oil, peanut oil, cashew oil, hazelnut oil, macadamia oil, pecan oil, pistachio oil, acai oil, blackcurrant seed oil, borage seed oil, evening primrose oil, amaranth oil, apricot, aragan oil, wheat germ oil, walnut oil, drying oils, plant terpene oil, lampant oil, pumpkin seed oil, rice bran oil, safflower seed oil, sesame seed oil, sunflower seed oil, soybean oil, sorghum oil, walnut oil, non-edible oils, and oils from their associated plant meals from processing. For example, the plant oil or vegetable oil may comprise or consist palm oil, soybean oil, cottonseed oil, canola oil, or sunflower oil. The plant oil or vegetable oil may comprise or consist canola oil, sunflower oil, or soybean oil. The plant oil or vegetable oil may be canola oil. The plant or vegetable oil may be sunflower oil. The plant or vegetable oil may be soybean oil.

### Chemical Process and Megasonic Parameters

It will be appreciated that the process described by the present disclosure may apply to processes such as separation of free fatty acids, phosphatides, waxes, pigments, peroxides, and oxidation by-products as well as health driven compounds such as phenolics or vitamins.

The alkali refining (also known as alkali neutralisation) or degumming process described herein may refer to oil or related compound separation from oil bearing materials such as seeds (canola, soybean, grapeseed, cottonseed, flaxseed, hemp), fruits (palm, olive, coconut, avocado oils), vegetables (corn oil), peels or pomaces (citrus oil), beans (spent coffee), or other oily plant parts (e.g., rice bran; GM tobacco leaves). The process described by the present disclosure may apply to animal oil or fat or animal parts such as tissue, blood, skin, hair or flesh, e.g., tallow, wool wax, or oil from other biological sources (e.g., freshwater and marine product meals such as algal, fishmeal, and krill meal), as well as waste water by-products.

### 1. Temperature

In some embodiments of examples, the crude oil described in step (a) of the chemical process may be subjected to a heating step. The crude oil may be pre-heated prior to chemical treatment. In an embodiment, the crude oil may be subjected to a temperature of between about 0° C. and 150° C. in step (a). In some embodiments or examples, the temperature of the crude oil in step (a) may be in a range of about 20° C. and 100° C., about 30° C. and 98° C., about 40° C. and 96° C., about 50° C. and 94° C., or about 60° C. and 90° C. The temperature of the crude oil in step (a) may be at least 5° C., 10° C., 20° C., 30° C., 40° C., 50° C., 60° C., 70° C., 80° C. or about 90° C. The temperature of the crude oil in step (a) may be less than 150° C., 120° C., 100° C., 90° C., 80° C., 70° C., or 60° C. The temperature of the crude oil in step (a) may be in a range provided by any two lower and/or upper values as previously described.

In some embodiments or examples, the mixture of oil and gum phases (‘the mixture’) may be subjected to a temperature of about 0° C. and 150° C. in step (b). It will be appreciated that the mixture of oil and gum phases may be pre-heated prior to a megasonic treatment step. It will also be appreciated that the mixture may be heated during a megasonic treatment step. In some embodiments or examples, the temperature of the mixture in step (b) may be in a range of about of about 5° C. and 120° C., about 10° C. and 100° C., about 15° C. and 90° C., about 20° C. and 80° C., or about 30° C. and 60° C. The temperature of the mixture in step (b) may be at least 5° C., 10° C., 15° C., 20° C., 25° C., 30° C., 35° C., 40° C., 45° C., or 50° C. The temperature of the mixture in step (b) may be less than 120° C., 110° C., 100° C., 90° C., 80° C., 70° C., 60° C., or 50° C. The temperature of the mixture in step (b) may be in a range provided by any two lower and/or upper values as previously described.

### 2. Mixing Methods

In some embodiment or examples, the mixture in step (b) may be further subjected to a mixing step. The mixing step may include, but not limited to, one or more of shearing, blending, shaking, low frequency ultrasound emulsification, vibration, vortexing, stirring, shockwaves, sonication, cavitation, aeration, boiling or any other mixing method known in the art. In an embodiment, the mixing step may be a high shear mixing step.

In an embodiment, a high shear mixing step may be applied to the mixture in step (b) prior to a megasonic treatment step. In an embodiment, the mixture may be pre-heated subsequent to a high shear mixing step and prior to a megasonic treatment step. In some embodiments or examples, the mixing speed in step (b) may be from between about 100 rpm to about 20,000 rpm. The mixing speed may be in a range from about 200 rpm to about 10,000 rpm, about 300 rpm to about 7,500 rpm, about 400 rpm to about 5,000 rpm, or about 500 rpm to about 2,500 rpm. The mixing speed may be at least 100, 200, 300, 400, 500, 600, 700, 800, 900, or 1,000 rpm. The mixing speed may be less than 20,000, 15,000, 10,000, 7,500, 5,000, 2,500, or 1,000 rpm. The mixing speed may be in a range provided by any two lower and/or upper values as previously described.

It will be appreciated that the centrifugal force (g) exerted on the mixture in the separation step (b), e.g. in a centrifuge, may be a function of the rotation speed of the centrifuge (rpm) and the radius of the rotor. A person skilled in the art will also appreciate that at the same rotational speed (rpm), the centrifugal force (g) applied to the mixture can vary as a function of the radius of the rotor, for example, when mixing at a speed of about 3,500 rpm, a large rotor with a radius of 15 cm will produce a maximum G-Force of 2,058 g, while a small rotor with a radius of 5 cm will produce a maximum G-Force of 686 g. In some embodiments or examples, the centrifugal force (g) applied to the mixture in step (b) may be from between about 1,000 g to about 6,000 g. The centrifugal force (g) may be in a range from about 1,500 g to about 5,500 g, about 2,000 g to about 5,000 g, or about 3,000 g to about 4,000 g. The centrifugal force (g) may be at least about 1,000, 1,500, 2,000, 2,500, 3,000, 3,500, 4,000, 4,500, 5,000, 5,500, or 6,000 g. The centrifugal force (g) may be less than 6,000, 5,500, 5,000, 4,500, 4,000, 3,500, 3,000, 2,500 or 2,000 g. The centrifugal force (g) may be in a range provided by any two lower and/or upper values as previously described.

In some embodiments or examples, the mixture in step (b) may be subjected to the separation step for between about 30 seconds to about 500 minutes. The mixture may be subjected to centrifugal force for about 1 minute to about 250 minutes, about 2 minutes to about 100 minutes, about 4 minutes to about 60 minutes, about 5 minutes to about 30 minutes, or about 10 minutes to about 20 minutes. The mixture may be subjected to centrifugal force for at least 30 seconds, 1 minute, 2 minutes, 3 minutes, 4 minutes, 5 minutes, 6 minutes, 7 minutes, 8 minutes, 9 minutes or 10 minutes. The mixture may be subjected to centrifugal force for less than 500 minutes, 250 minutes, 100 minutes, 60 minutes, 30 minutes, 20 minutes, or 10 minutes. The mixture may be subjected to centrifugal force in a range provided by any two lower and/or upper values as previously described.

In some embodiments or examples, the pH of the mixture in step (b) may be about 0 to 14. For example, the pH may be about 2 to 12, or about 4 to 8. For another example, the pH may be 4.5 to 7.5.

### 3. Transducers and Megasonic Frequency

The present invention seeks to employ standing waves at high ultrasonic frequencies typically greater than 100 kHz to facilitate the separation of oil from solids, such as vegetal solids. It will be appreciated that it is a limitation of current ultrasonic equipment design and material limitations that at frequencies above 100 kHz it is not feasible to use any form of ultrasonic horn to propagate ultrasound. Current ultrasonic horn designs generally enable operation between 20 to 24 kHz. This means that, unlike the piezo-electric wafer stacks used to drive horn transducers, single wafer piezo-electric transducers bonded to plate surfaces are required to achieve frequencies above 100 kHz. Plate transducers operate at specific amplitudes very much lower than those accomplished by horn transducers.

At frequencies greater than 400 kHz it is practical to produce large area standing waves at low amplitudes. Juliano et al.^{1,2} disclose that high frequency standing waves, also denominated megasonics, accomplish phase separations on the basis of the relative specific gravities of the phases. It has been shown that when presenting an emulsion primary acoustic forces will separate the oil to the wave antinodes. Other studies teach that in order to obtain coalescence of the oil it is necessary for secondary acoustic forces perpendicular to the standing wave plane to develop as a result of the wave field being bounded by walls perpendicular to the plane of the waves. The minimum temperature at which standing waves can be used to separate oil from water is limited by the increasing viscosity of the oil as the temperature is reduced. For example, ideally for triglyceride vegetable oils the temperature should be as low as is practical to minimize the potential for hydrolysis of free fatty acids, oxidation of unsaturated fatty acids and destruction of sensitive phytochemicals inherent in the oils.

The inventors of the present disclosure have unexpectedly found that reducing the temperature of the chemical separation processes (e.g. between about 60° C. and 90° C.) and combining this with megasonic treatment (e.g. between about 30° C. and 60° C.) may resulted in an increased oil quality and yield, which simultaneously resulted in an increased gum quality and yield.

It will be appreciated that a 10-30% reduction in oil loss is economically significant.

It will also be appreciated that gum quality and yield is economically significant, as gums can be used to produce high value products such as lecithin.

In some embodiments or examples, the megasonic treatment step, step (b), may comprise the use of megasonic frequencies of between about 100 kHz to about 10 MHz. The megasonic treatment step may be applied to the mixture of step (b) to produce a refined oil phase and refined gum phase. In some embodiments or examples, the megasonic frequency may be in a range from about 400 kHz to 10 MHz, about 500 kHz to about 9 MHz, about 600 kHz to about 4 MHz, about 800 kHz to about 3 MHz, or about 1 MHz to about 2 MHz. The megasonic frequency may be at least 100 kHz, 200 kHz, 300 kHz, 400 kHz, 500 kHz, 600 kHz, 700 kHz, 800 kHz, 900 kHz, 1 MHz, or 2 MHz. The megasonic frequency may be less than 10 MHz, 9 MHz, 8 MHz, 7 MHz, 6 MHz, 5 MHz, 4 MHz, 3 MHz, 2 MHz, or 1 MHz. The megasonic frequency may be in a range provided by any two lower and/or upper values as previously described.

In some embodiments or examples, the process of step (c) may comprise subjecting the megasonic treated mixture of refined oil and aqueous gum or emulsion phase to at least one centrifugation step.

In some embodiments or examples, the process may further comprise step (d) subjecting the gum phase to (i) a megasonic treatment step and (ii) a separation step.

In a further embodiment, the process described herein may be performed as a continuous, semi-continuous or batch process.

### Oil Recovery and Phosphatide Content

The phosphorus content of refined oil described herein may be measured using nephelometry (turbidity). It will be appreciated that the nephelometeric method measures turbidity in oil-acetone mixtures due to phospholipids. The turbidity is correlated to the phosphorus level. It has been unexpectedly observed that combining chemical treatment and megasonic treatment may provide an enhanced efficiency on the phosphatide reduction of crude oils, thereby providing a high quality refined oil. For example, the process described by the present invention may provide a reduction in the phosphorous content of crude oils by at least about 40%.

The residual phosphatide content in degummed oil was monitored by measuring phosphorous content using the nephelometeric phosphorus determination method (American Oil Chemists' Society (AOCS) official method Ca 19-86), 1997. The oil sample (8 g) was placed into a 50 mL volumetric flask and diluted to 50 mL with acetone. The mixture was then agitated. Turbidity was measured in nephelometeric turbidity units (NTU) in a turbidimetric cell according to a designated turbidity range (0.02, 2, 20 and 100 NTU). The measured turbidity was used to calculate the phosphorus content using an equation referenced in the AOCS method.

In an embodiment or example, the process described by the present invention may provide a refined oil that may contain less than about 50 mg/kg phosphorus. It will be appreciated that the calculation of the gum content may depend on the ratio of the molecular weight (MW) of the predominant phospholipid in the particular oil of interest to that of phosphorus (P) and can be estimated by a person skilled in the art through the application of a multiplication factor, for example. MW Lecithin=758.1 and MW P=30.97, thus gum content=24.47 times P content.

The process described by the present disclosure may provide an improved reduction of entrained oil in gums and enhanced oil recovery, and enhance phospholipid removal and gum and lecithin recovery. For example, the recovered gum may contain less than about 60% of crude oil on a dry weight basis. A further advantage may be provided by the process and may enhance oil recovery from gums compared with conventional treatment processes. The process described by the present disclosure may reduce the amount of entrained oil in the gums by at least about 25% on a wet weight basis. The % reduction of entrained oils in gums (on a wet weight basis) may be in a range of about 20% to about 60%. The % reduction of entrained oils in gums (on a wet weight basis) may be at least about 25, 30, 35, 40, 45, 50, 55 or 60%. The % reduction of entrained oils in gums (on a wet weight basis) may be less than about 60, 55, 50, 45, 40, 35, 30 or 25%. The % reduction of entrained oils in gums (on a wet weight basis) may be in a range provided by any two lower and/or upper values as previously described.

### EXAMPLES

The present disclosure is further described by the following examples. It is to be understood that the following description is for the purpose of describing particular examples only and is not intended to be limiting with respect to the above description.

### Example 1—Purification of Crude Canola oil

Crude soybean and sunflower oils (expeller oil) were obtained from GrainCorp Foods (Victoria, Australia) and two crude canola oils were obtained from the pressing of canola seeds and the hexane extraction stripper (Cargill Company, Victoria, Australia). The phosphorus and free fatty acids (FFA) content of crude soybean, canola and sunflower oil were given by supplier and are shown in Table. 1.

TABLE 1
Crude oils specifications

| | Canola | Canola | Soybean | Sunflower |
|---|---|---|---|---|
| Specifications | oil* | oil** | oil | oil |
| Phosphorus | 400.0 ± 15 | 550.0 ± 20 | 750.0 ± 40 | 300.0 ± 20 |
| content | | | | |
| (mg/kg) | | | | |
| FFA (g | 1.4 ± 0.2 | 1.7 ± 0.3 | 2.8 ± 0.4 | 2.0 ± 0.3 |
| oleic acid, %) | | | | |

Canola oil*: crude expeller-pressed oil.
Canola oil**: crude oil from the hexane extraction stripper.

### Example 1a—Water Degumming

Water degumming was carried out by heating 100 g of crude oil to 80° C., mixing with 2% water (oil sample weight basis, w/w), and then shearing intensively for approximately 3 minutes using three different mixing techniques described in example 1f. The mixtures samples were then heated to 40° C., and treated as described further below in example 1g. Both samples were then centrifuged at 4000 g for 20 minutes at 20° C. (Example 1h).

### Example 1b—Acid Degumming

Acid degumming was carried out by heating 100 g of crude oil to 80° C., mixing the oil with 2% water (oil sample weight basis, w/w), mixing with phosphoric acid (14%, v/v) in amount of 10% by volume of crude oil, with intensive shear mixing for approximately 3 minutes using three different mixing techniques described in example 1f. The mixtures were then heated to 40° C., and treated as described further below in example 1g. Both samples were centrifuged at 4000 g for 20 minutes at 20° C. (Example 1h).

### Example 1c—Second Acid Degumming

A second acid degumming procedure consisted of heating 100 g of crude oil to 80° C., mixing with 2% water (oil sample weight basis w/w), and adding a 30% citric acid (w/v) solution in the amount of 2% by volume of the crude oil, and then stirring intensively for approximately 3 minutes using three different mixing techniques described in Example 1f. The mixtures were then heated to 40° C., and treated as described further below in example 1g. Both samples were centrifuged at 4000 g for 20 minutes at 20° C. (Example 1h).

### Example 1d—Alkali Neutralisation

Alkali neutralisation may be carried out by heating 100 g of crude oil to 80° C., mixing the oil with 20% (w/v) alkali solution in amount of 10% by volume of crude oil, with intensive shear mixing for approximately 3 minutes using three different mixing techniques described in example 1f. The mixtures may then be heated to 40° C., and treated as described further below in example 1g. Both samples may then be centrifuged at 4000 g for 20 minutes at 20° C. (Example 1h).

### Example 1e—Total Degumming

The total degumming process consisted of heating 100 g of crude oil to 80° C., mixing with 2% water, then mixing with phosphoric acid (14%, w/v) in amount of 0.1% by weight of crude oil, and then stirred intensively for approximately 3 minutes using three different mixing techniques described in example 1e. A solution of 20% of NaOH (w/v) was then added as 10% of the oil volume to partially neutralize the acid. The mixtures were then heated to 40° C., and then treated as described below in example 1g. Both samples were centrifuged at 4000 g for 20 minutes at 20° C. (Example 1h).

### Example 1f—Mixing Techniques

After chemical addition, three mixing techniques were tested to identify their influence on phospholipids removal or phosphorus content. Firstly, shaking was carried out by hand (gentle mixing) for 3 min. Secondly, applying shear force by using an ultra-turrax probe (Ultra-Turrax-T25, Janke & Kunkel, Germany) at 9100 rpm prior to non-megasonic and megasonic treatment for 3 min (ultra-turrax 1 pass). Lastly, a double shear force treatment was applied before and after non-megasonic and megasonic treatment, for 3 min each (ultra-turrax 2 passes).

### Example 1g—Megasonic Treatment

For all chemical processes, the mixtures were prepared by irradiating the sheared pre-heated mixture with 2 MHz (220 W) for approximately 20 minutes. The megasonic procedure consisted of placing 100 g of crude oil in a 120 mL glass test tube inside the megasonic reactor. The high frequency megasonic reactor, consisted of a rectangular stainless steel vessel of 40×21×20 cm containing a 0.4, 1 or 2 MHz transducer plate (16×16×3.2 cm), (Sonosys, Neuenbuerg, Germany). Transducer cooling was required for operations beyond 40° C. and achieved by recirculating cooled water through a jacket around the transducer plate. The reactor was filled with water, set at the test temperatures and controlled by an electrical heater.

### Example 1h—Separation

In all mixtures, the water phase and gums were separated from the oil phase by using a laboratory centrifuge (Centrifuge J6-MI, Beckman Coulter, Pasadena, USA) at a 4000 g for 20 minutes at 20° C.

### Example 2: Megasonic Assisted Reduction of Oil Entrained in Gums

The procedure allowed the quantification of the total recovered oil after degumming by separating the gums from the filtered oil.

The residual oil in the wet filtered gums i.e. after degumming and filtering, was determined via hexane extraction of the wet gums. Hexane extraction was performed by mixing 20 mL of hexane with the wet filtered gums in a falcon tube. The tube was heated for 10 min in a 60° C. water bath, and then centrifuged (Centrifuge J6-MI, Beckman Coulter, Pasadena, USA) at 3000 g for 20 minutes at 25° C. The hexane layer was transferred into a pre-weighed 50 mL centrifuge tube for overnight drying in a SpeedVac concentrator (Savant SC250EXP, Thermo Scientific, Australia) with a refrigerated vapour trap (Savant RVT4104, Thermo Scientific, Australia) and weighed again to determine the amount of residual oil in wet gums.

### Example 2a: Method I—Quantification of Canola Oil, Soybean, and Sunflower Entrained in Gums Via Hexane Extraction (Wet Weight Basis)

Table 2 (method I) shows the quantity of the residual entrained oil in gums after phosphoric acid degumming without and with megasonic treatment on a wet basis determined by the hexane extraction method. The megasonic treatment reduced the residual entrained oil in gums of two types of crude canola oils (expeller oil and hexane extracted oil from pressed cake) compared with the non-megasonic treatment by nearly a 47% (20.0 vs. 10.8 g/kg for expeller oil and 40.2 vs. 21.3 g/kg for hexane extracted oil), respectively. This indicates that the combined chemical and megasonic treatment is effective independently from the original amount of oil entrapped by the gums. A similar trend was seen for soybean and sunflower gums, where the entrained oil was reduced by 35% and 24%, respectively (Table 2). It can be concluded that the combined chemical and megasonic assisted treatment process unexpectedly enhanced oil recovery compared with conventional treatment.

### Example 2b: Method II—Quantification of Canola Oil, Soybean Oil and Sunflower Oil Entrained in Gums Via Acetone Extraction (Wet Weight Basis)

Following a similar procedure to Example 2a, unrecovered oil in gums was determined gravimetrically by cold acetone as specified in the industrial standard. The extraction was carried out with cold acetone at 0° C. in a wet gum-solvent ratio of 1:1.5 w/v, with continuous shaking for 30 minutes. After resting for 15 min the extract was separated by filtration. The residue was extracted further twice by repeating the extraction with cold acetone (1:1, w/v) under the same conditions. The oil was recovered by evaporation of the solvent under vacuum at 40° C. with centrifugation using a SpeedVac concentrator (Savant SC250EXP, Thermo Scientific, Australia) with a refrigerated vapour trap (Savant RVT4104, Thermo Scientific, Australia) and the oil trapped in the gums was determined gravimetrically.

The recovered oils were also determined by using acetone on the wet gum basis. This method is traditionally used by industry to verify the results obtained with hexane. Table 2 (method II) shows the residual entrained oil in gums after phosphoric acid degumming without and with megasonic treatment. It was observed that the amounts of oils recovered from the 3 types of gums were higher than the hexane method. The megasonic treatment unexpectedly reduced the entrained oil by 50% and 45% for the two studied canola oils, and by 35.3% and 28.4%, for soybean and sunflower, respectively. The combined chemical and megasonic treatment process recovered oil up to 187 g/kg wet gums.

### Example 2c: Method III—Quantification of Canola Oil, Soybean, and Sunflower Entrained in Gums Via Hexane Extraction (Dry Gum Basis)

To correct for the water content in the wet gums, a second determination was carried out using the same method to acid degumming described above in Example 1a, except that the filtered gums were placed in a freeze dryer for two days to dry, and then quantified gravimetrically. The entrained oil in the dehydrated gums was measured using the hexane extraction method described above in Example 2a and expressed on a dry gum basis.

Table 2 (method III) shows the quantity of recovered oil in gums after phosphoric acid degumming without and with megasonic treatment on a dry gum basis determined by the hexane extraction method. Megasonic assisted acid degumming reduced the entrained oil recovered in gums for two types of canola oil (expeller pressed and hexane extracted) by 50%, while soybean and sunflower by 35.5% and 24.3%, respectively. The entrained oil reduction in gums estimated from the three quantification methods were not significantly different. Megasonic assisted acid degumming unexpectedly and greatly reduced the entrained oil in gums and enhanced oil recovery for the three seed oils independent of whether the oil was produced by expeller pressing or hexane extraction. Assuming an annual production of 100,000 tons of oil per year in a traditional canola oil refinery, this translates to an additional oil recovery of 310-320 tons of oil valued at approximately US$250,000-260,000.

TABLE 2
The residual entrained oil in gums (g/kg)

| | Gums | | | | | | | |
|---|---|---|---|---|---|---|---|---|
| | Canola* | | Canola** | | Soybean*** | | Sunflower*** | |
| Method | C | MS | C | MS | C | MS | C | MS |
| I | 20.0 ± 2.3 | 10.8 ± 4.5 | 40.2 ± 11.3 | 21.3 ± 5.5 | 50.0 ± 10.2 | 32.5 ± 11.5 | 39.5 ± 8.0 | 30.0 ± 7.5 |
| II | 25.5 ± 4.5 | 12.5 ± 3.1 | 45.5 ± 12.7 | 25.0 ± 10.3 | 98.4 ± 12.2 | 63.7 ± 15.5 | 85.5 ± 12.0 | 61.2 ± 14.5 |
| III | 15.1 ± 2.5 | 7.5 ± 1.5 | 22.4 ± 7.5 | 10.4 ± 5.3 | 30.2 ± 6.0 | 19.5 ± 7.5 | 20.5 ± 3.1 | 15.5 ± 2.2 |

Method I: n-hexane extraction method (wet basis).
Method II: acetone extraction method (wet basis).
Method III: n-hexane extraction method (dry basis).
*Canola: gums separated from oil obtained from expeller pressing.
**Canola: gums separated oil obtained from hexane extraction stripper.
***Soybean and sunflower: gums separated from oil obtained from expeller pressing.

### Example 3a: Effect of Frequency and Temperature in Megasonic Treatments on Phospholipid Removal, Free Fatty Acid and Peroxide Value, and Chlorophyll Content After Acid Degumming

The effect of megasonic frequency and treatment temperature on the effectiveness of gum removal from crude canola oil was studied following a factorial experimental design. The acid degumming procedure described above in Example 1b was followed with and without a megasonic treatment step after shearing. A 3×3 factorial design included variations in megasonic frequency (0.4, 1, and 2 MHz) and treatment temperature (40, 60, and 80° C.), while other megasonic parameters were fixed (treatment time 30 minutes, power 350 W, and specific energy 210 kJ/kg) and a 3 minute oil and acid shearing time. Each frequency-temperature combination included a non-megasonic trial and all trials were performed in triplicate.

The residual phospholipid content in degummed oil was determined by measuring phosphorous content using the nephelometeric phosphorus determination method (AOCS official method Ca 19-86), 1997. The degummed oil sample (8 g) was placed into a 50 mL volumetric flask, followed by dilution with acetone to 50 mL. The mixture was then agitated. Turbidity was measured in a turbidimetric cell according to a designated nephelometric turbidity unit range (0.02, 2, 20 and 100 NTU). The measured turbidity was used to calculate the phosphorus level using the following equation referenced in the AOCS method.

Phosphorus content (mg/kg)=(5.32*turbidity)+3.38 (1)

The determination of free fatty acids (FFA) and peroxide value (PV), was carried out according to the procedures given by IUPAC “Standard methods for the analysis of oils, fats and derivatives” (No's 2.501, 5.501, 2.421). The chlorophyll content was determined by the method described by Barthet and Daun (Canola. 2011, Elsevier. p. 119-162) using the absorption spectra at 470 and 670 nm according to the following equations:

Chlorophyll (ppm)=(A670*106)/613*100*L (2)

Where A is the absorbance and L is the spectrophotometer cell thickness (10 mm).

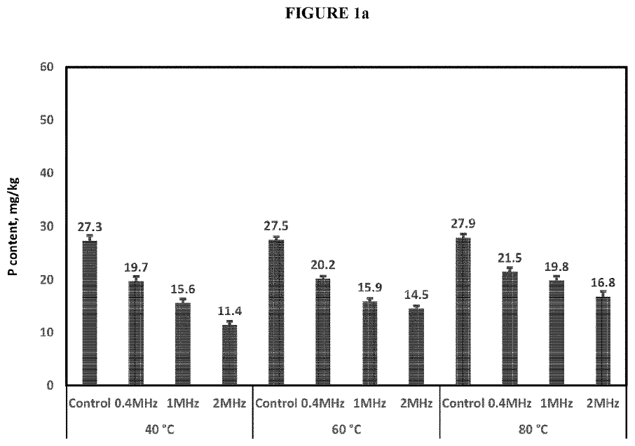

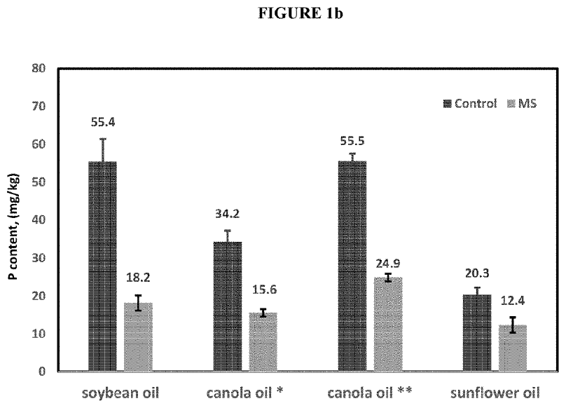

FIG. 1a shows that all megasonic frequencies (0.4, 1, and 2 MHz) used during acid degumming showed significant phosphorous reduction in degummed oil at all tested temperatures. The most effective megasonic frequency was 2 MHz which showed a significant reduction in phosphorus content of 58.3, 47.1, and 40.0% at treatment temperatures of 40, 60, and 80° C., respectively. This experiment shows that megasonic treatment at 2 MHz and 40° C. resulted in the greatest reduction in phosphorus content of the oil (Table 3) compared with megasonic treatment at higher temperatures of 60° C. and 80° C. with decreasing efficacy as treatment temperature increased. The higher oil recovery at a lower temperature of 40° C. implies lower energy requirements due to lower heating requirement. Degumming at lower temperatures can also provide better quality gums and oils due to minimisation of thermal degradation.

TABLE 3
Preferred megasonic treatment parameters
for acid degumming of canola oil

| | | |
|---|---|---|
| f | frequency | 2 MHz |
| T | temperature | 40° C. |
| t | time | 20 min |
| P | power | 340 W |
| Es | specific energy | 81.6 kJ/Kg |

### Example 4b: Megasonic Reduction of Phospholipid Gums in Canola Oil, Sunflower Oil and Soybean Oil

Using the experimental method above in Example 3a, the effectiveness of gum removal from crude canola oil (crude oil from pressing and crude oil from hexane extraction stripper), sunflower oil and soybean oil was studied using the preferred parameters described in Table 2 and shown in FIG. 1b.

It was unexpectedly observed that megasonic treatment of the 4 oils tested had significantly enhanced phosphatide reductions compared to the non-megasonic treated degummed oils in these. Megasonic treatment reduced the phosphorus content compared with the non-megasonic (control) degummed oil from 55.4 mg/kg to 18.2 mg/kg (67% reduction), for soybean oil. Megasonic treatment reduced the phosphorus content compared with the non-megasonic (control) degummed oil from 55.4 mg/kg to 24.9 mg/kg (55% reduction), for canola oil (crude oil from hexane extraction stripper). Canola oil (crude expeller pressed oil) and sunflower oil showed marginally smaller phosphorus reductions as a result of megasonic treatment compared with non-megasonic treatment (from 34.2 mg/kg to 15.6 mg/kg for canola, respectively, and from 20.3 mg/kg to 12.4 mg/kg, for sunflower, respectively).

### Example 3c: Increase in Gum Yield from Megasonic Treatment of Canola Oil, Sunflower Oil and Soybean Oil

Table 4 provides a comparison of gum yields obtained in soybean, canola and sunflower oils after using 100 g oil for each trial. For trials carried out using several crude seed oils, gum weight was quantified after megasonic treatment and without megasonic treatment. Table 3 includes the comparisons of gum yields obtained for soybean, canola and sunflower oils after using 100 g oil for each degumming trial. It was found that after megasonic treatment of the crude degummed mixtures, the gum yield was enhanced by 22.7%, 22.2%, 18.7% and 15.9% for pressed canola oil, canola oil recovered by hexane extraction of pressed cake, soybean and sunflower oil respectively.

TABLE 4
Gum yield (g) for canola oil, sunflower oil and soybean oil

| | Gum weight (g) per 100 g of oil | | | |
|---|---|---|---|---|
| | Canola gums* | Canola gums** | Soybean* | Sunflower* |
| Control | 1.7 ± 0.3 | 17.5 ± 0.9 | 16.5 ± 0.9 | 14.2 ± 0.6 |
| (non- | | | | |
| megasonic) | | | | |
| megasonic | 2.2 ± 0.3 | 22.5 ± 1.0 | 20.3 ± 1.2 | 16.9 ± 0.5 |

Canola gums*: canola gums recovered from degumming crude expeller pressed oil.
Canola gums**: canola gums recovered from degumming of crude oil from hexane extracted pressed cake.

### Example 4: Megasonic Reduction of Phospholipid Gums in Canola Oil During Application of Other Degumming Methods

In addition to the use of acid degumming describe in the above examples, the present example investigated the ability of megasonic application for enhanced removal of phospholipids using other degumming methods, i.e., water degumming (Example 1a), second acid degumming (Example 1c), and total degumming (Example 1d). The degumming processes were followed as explained above with and without megasonic treatments at 40° C. and a shearing time of 3 minutes. The megasonic treatments were carried out by sonicating with a 0.4, 1 and 2 MHz frequency for 20 minutes at 350 W (Es=140 kJ/kg). Statistical differences were determined through analysis of variance with a 95% confidence level.

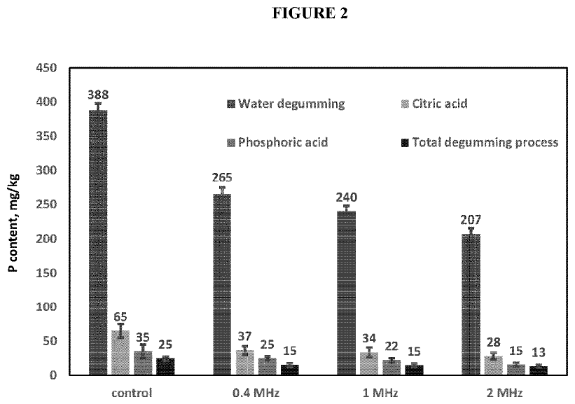

FIG. 2 shows the megasonic frequency effects on phospholipid content in the degummed oils. It was surprisingly found that a 2 MHz frequency provided the greatest reduction in the phosphorous content for canola oil when using all degumming methods. When compared with the phosphorus content remaining in the oil of the non-sonicated control samples, it was shown that the phospholipid reduction at 2 MHz was 47% for the water degumming process, 48% for the total degumming process, and 57% for both acid and second acid degumming process. The present example suggests that significant reagent use can be reduced or other energy savings could be achieved through centrifugal energy reduction by the application of megasonic treatments.

### REFERENCES

1. Juliano, P., et al., Advances in high frequency ultrasound separation of particulates from biomass. Ultrasonics Sonochemistry, 2017. 35: p. 577-590.
2. Juliano, P., et al., Extraction of olive oil assisted by high-frequency ultrasound standing waves. Ultrasonics Sonochemistry, 2017. 38: p. 104-114.

1. A process for refining crude oil to produce a refined oil and/or a refined gum, the process comprising the steps of:
(a) subjecting the crude oil to a chemical process to produce a mixture comprising an oil phase and a gum phase; and
(b) subjecting the mixture obtained in step (a) to a megasonic treatment step, wherein megasonic frequencies of at least about 100 kHz are used to produce a refined oil phase and/or a refined gum phase; and
separating the phases obtained in step (b) to obtain a refined oil and/or a refined gum.

2. The process of claim 1, wherein the crude oil is selected from the group comprising oil, fat, lipid or oil bearing material.

3. The process of claim 1 or 2, wherein the crude oil comprises at least one of animal oil, plant oil, or vegetable oil.

4. The process of claim 3, wherein the animal oil is selected from the group comprising fish oil, krill oil, squid oil, mussel oil, oyster oil, fish liver oil, seafood oil, micro-algal oil, macro-algal oil, lanolin, beef fat, pork fat, chicken fat, lamb fat, egg fat, tallow, dripping, seal oil, whale oil, wool oil, fish eggs oil, animal products oil, animal tissue oil, animal organ oil, animal blood oil, and associated animal meal oil from processing.

5. The process of claim 3, wherein the plant oil or vegetable oil is selected from the group comprising plant leaf oil, palm oil, marine plant oil, micro-algal oil, macro-algal oil, palm kernel oil, coconut oil, nut oil, seed oil, clove oil, perilla oil, moringa seed oil, almond oil, avocado oil, avocado seed oil, banana leaf oil, canola oil, cocoa butter, corn oil, cottonseed oil, flax seed oil, blackseed oil, grapeseed oil, hemp oil, cannabis oil, olive oil, peanut oil, cashew oil, hazelnut oil, macadamia oil, pecan oil, pistachio oil, acai oil, blackcurrant seed oil, borage seed oil, evening primrose oil, amaranth oil, apricot, aragan oil, wheat germ oil, walnut oil, drying oils, plant terpene oil, lampant oil, pumpkin seed oil, rice bran oil, safflower seed oil, sesame seed oil, sunflower seed oil, soybean oil, sorghum oil, walnut oil, non-edible oils, and oils from their associated plant meals from processing.

6. The process of claim 4, wherein the plant oil or vegetable oil is palm oil, soybean oil, cottonseed oil, canola oil, or sunflower oil.

7. The process of any one of the preceding claims, wherein in step (a) the chemical process comprises addition of water, at least one acid, at least one alkali, or a combination thereof.

8. The process of claim 7, wherein the at least one acid is selected from phosphoric acid, hydrochloric acid, sulfuric acid, ascorbic acid, formic acid, acetic acid, propionic acid, citric acid, fumaric acid, maleic acid, tartaric acid, succinic acid, glycolic acid, carbonic acid, nitric acid, ionic liquids or combinations thereof.

9. The process of claim 8, wherein the acid is selected from phosphoric acid or citric acid.

10. The process of claim 7, wherein the at least one alkali is selected from sodium hydroxide, potassium hydroxide, sodium silicate, sodium carbonate, sodium bicarbonate, organic and inorganic bases such as amines, ammonium salts, ionic liquids, calcium carbonate, or combinations thereof.

11. The process of claim 10, wherein the base is selected from sodium hydroxide or potassium hydroxide.

12. The process of any one of the preceding claims, wherein in step (b) the megasonic treatment step comprises the use of megasonic frequencies of about 100 kHz to about 10 MHz.

13. The process of any one of the preceding claims, wherein in step (b) the megasonic treatment step comprises the use of megasonic frequencies of about 400 kHz to about 10 MHz, or about 600 kHz to about 4 MHz.

14. The process of any one of the preceding claims, wherein in step (a) the crude oil is subjected to a temperature of about 0° C. and 150° C.

15. The process of any one of the preceding claims, wherein in step (a) the crude oil is subjected to a temperature of about 20° C. and 100° C.

16. The process of any one of the preceding claims, wherein in step (a) the crude oil is subjected to a temperature of about 60° C. and 90° C.

17. The process of any one of the preceding claims, wherein in step (b) the mixture is subjected to a temperature of about 0° C. and 150° C.

18. The process of any one of the preceding claims, wherein in step (b) the mixture is subjected to a temperature of about 20° C. and 100° C.

19. The process of any one of the preceding claims, wherein in step (b) the mixture is subjected to a temperature of about 30° C. and 60° C.

20. The process of any one of the preceding claims, wherein in step (b) the mixture is further subjected to a mixing step.

21. The process of any one of claims 20 to 20, wherein in step (b) the mixture is subjected to high shear mixing step for about 30 seconds to about 500 minutes.

22. The process of claim 21, wherein the mixture is subjected to high shear mixing step for about 5 minute to about 30 minutes.

23. The process of any one of the preceding claims, wherein in step (b) the pH of the mixture of refined oil and an aqueous gum phase is about 0 to 14, or about 2 to 12, or about 4 to 8.

24. The process of any one of the preceding claims, wherein the process of step (c) comprises subjecting the phases to at least one centrifugation step.

25. The process of any one of the preceding claims, wherein the process further comprises step (d) subjecting the refined oil and/or the refined gum to (i) a megasonic treatment step and (ii) a separation step.

26. The process of an one of the preceding claims, wherein the % reduction of entrained oils in gums (on a wet weight basis) is in a range of about 20% to about 60%.

27. The process of any one of the preceding claims, wherein the recovered gum contains less than about 60% of crude oil on a dry weight basis.

28. The process according to any one of the preceding claims, wherein the process is a continuous, semi-continuous or batch process.

29. A refined oil prepared by the process of any one of the preceding claims.

30. A refined gum prepared by the process of any one of the claims 1 to 27.
